(19) United States
(12) Patent Application Publication
(10) Pub. No.: US 2004/0143467 A1
(43) Pub. Date: Jul. 22, 2004

(54) Method and system for optimization of environmental compliance

(76) Inventors: Richard Eugene McAllister, Orefield, PA (US); Beth Brandes Jenkins, Bellair, TX (US); Bruce Edward Snyder, Pottstown, PA (US); David Joseph Ashworth, Coopersburg, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/349,232

(22) Filed: Jan. 22, 2003

(51) Int. Cl. G06F 17/60

(52) U.S. Cl. 705/7

(57) ABSTRACT

A method for enabling an entity of a group of entities in a region to comply with a regulation regarding a pollutant to be discharged in the region from a point source operated by an entity includes: establishing an administrator in communication with the entities; establishing an amount of discharge of the pollutant from a point source operated by a first entity within the region during a period; comparing the amount of discharge of the pollutant from the point source and an amount of allowance allocated to the first entity during the period to assess compliance of the first entity with the regulation; establishing a value for the amount of allowance to be allocated by the first entity to discharge the pollutant from the point source; communicating that value to the administrator or a second entity; and defining a solution enabling the first entity to comply with the regulation.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to methods for complying with environmental regulations, and in particular to a method for enabling one or more entities within a group of entities located in a geographic region to comply with environmental regulations with respect to pollutants discharged from one or more sources operated by one or more of the entities.

The method and system of the present invention may be applied in any geographic region of the world where entities must comply with the applicable environmental regulations. The invention is discussed herein within the context of the environmental regulations applicable to air pollution in the United States. Persons skilled in the art will recognize, however, that the invention may be applied in the context of other regulations and/or in other jurisdictions. For example, the invention could be applied in the context of regulations applicable to water pollution (e.g., regulations promulgated in the U.S. under the Clear Water act and/or different environmental regulations in other countries.

The Clean Air Act (CAA) was enacted in the United States in 1963 and was later amended in 1977 and 1990. The CAA authorized the U.S. Environmental Protection Agency (EPA) to establish National Ambient Air Quality Standards (NAAQS) to protect public health and the environment and to establish regulations pertaining to air pollutants emitted from stationary, mobile, and other sources. The 1990 Clean Air Act Amendments (CAAA) addressed, inter alia, problems such as acid rain, ground-level ozone, stratospheric ozone depletion, and air toxics.

Title IV of the CAAA created a tradable emissions allowance system to control emissions of sulfur dioxide (SO2), the primary precursor of acid rain and other acidic depositions. The SO2 emissions control policy of Title IV of the CAAA was designed specifically to effect a substantial reduction in those depositions.

The SO2 tradable emissions allowance program relies on a market-based approach to controlling emissions rather than the traditional command-and-control approach of specifying source-specific standards. The program involves the specification of allowances for emissions that can be freely traded, and it gives electric utilities substantial flexibility in determining how the utilities will comply with the environmental regulations promulgated by the EPA under the CAAA.

There are many types of emissions trading approaches. The one used by EPA's Clean Air Market Programs is called “Allowance Trading” or “Cap and Trade” and has the following key features:

1. An emissions “cap”—a limit on the total amount of pollution that can be emitted from all regulated sources (e.g., power plants); the “cap” is set lower than historical emissions in order to cause reductions in emissions;

2. Allowances—an allowance is an authorization to emit a fixed amount of a pollutant;

3. Measurement—accurate tracking of all emissions;

4. Flexibility—sources can choose how to reduce emissions, including whether to buy additional allowances from other sources that reduce emissions;

5. Allowance Trading—sources can buy or sell allowances on the open market; and

6. Compliance—at the end of each compliance period, each source must own at least as many allowances as its emissions.

Under Title IV, aggregate annual caps on national SO2 emissions from certain electric generating units are specified by the statute. The caps define the number of emissions allowances issued for use in each year. An emissions allowance is the right to emit one ton of SO2 into the atmosphere. To legally emit SO2 into the atmosphere during a particular year, an electricity generator covered by the statute (an “affected source”) must have enough allowances which are good for use in that year to cover all of its emissions. The CAAA requires each affected source to have continuous emissions monitoring (CEM) equipment on each stack to measure actual SO2 emissions and to report those emissions to the EPA. At the end of each year, each source must have deposited enough allowances in an account maintained for it by the EPA to cover all of the recorded emissions or be subject to penalties (financial and legal).

Each allowance specifies a particular year, i.e., its “vintage,” in which the allowance is first available to be used to cover SO2 emissions. Also, an allowance may be “banked” and used in any future year. For example, a “2004 vintage” allowance can be used to cover emissions in 2004 or may be held for use in any later year, but it cannot be used to cover 2003 emissions. Significantly, all allowances are fully tradable, meaning that a source which has been allocated allowances is free to sell the allowances to any other source, including to a third party such as a broker or an individual. An affected source may buy allowances to cover its present emissions or its future emissions from any entity or person who has allowances available for trade. There are no limitations on how often parties can trade allowances or on the trading mechanisms that may be used to trade allowances.

In the U.S., most allowance trading has involved bilateral private trades between utilities that own electric generators, or between such utilities and third parties. These third parties include allowance brokers acting for their own account or on behalf of electricity generators, as well as fuel suppliers who bundle the sales of allowances with the sale of fuel to electric utilities. Allowances also have been traded on a lesser scale through annual auctions held by the EPA pursuant to the CAAA.

At the end of each year, each affected source must have enough allowances of appropriate vintages (the current year's vintage or earlier) in its account to cover its emissions for that year. Utilities that own multiple generating units (affected sources) may shift allowances between accounts to cover their emissions. When allowances are bought or sold through private transactions, the trades must eventually be recorded in the EPA's allowance tracking system in order for the allowances to be used to cover emissions.

Similar allowance trading programs exist for other pollutants, such as nitrogen oxides (NOx). For example, allowances for the emission of NOx can be traded under the Ozone Transport Commission NOx Budget Program (OTC NOx Budget Program). (Unlike the Acid Rain Program, the OTC NOx Budget Program does not hold an annual auction.)

The OTC NOx Budget Program includes a regional emission trading program to reduce NOx and thereby help control the transport of ground-level ozone in the eastern United States. A coalition of air regulators called the Ozone Transport Commission, which regulates utilities and major industrial sources such as the steel, paper, chemical, refining and cement industries, includes twelve states and the District of Columbia.

In the OTC Budget Program, sources are allocated allowances by the state where they are located. Each allowance permits a source to emit one ton of NOx during the control period (May through September) for which it is allocated or any later control period. For each ton of NOx discharge in a given control period, one allowance is retired and can no longer be used.

Allowances may be bought, sold, or banked. Any person may acquire allowances and participate in the trading system. Each source must comply with the program by demonstrating at the end of each control period that actual emissions do not exceed the amount of allowances held for that period. However, regardless of the number of allowances a source holds, it cannot emit at levels that would violate other federal or state limits.

A computerized system (NATS) is used to track the number of OTC NOx allowances held and used by any entity or person. Another computerized system (NETS) is used to track NOx emissions from NOx affected sources.

In addition to Allowance trading programs for SO2 and NOx, there is substantial potential for carbon dioxide (CO2) allowance trading in a global market. Although the United States has not joined other nations in the Kyoto Protocol, several states nevertheless are pursuing carbon dioxide (CO2) allowance trading programs.

Other countries already have allowance trading programs for CO2. For example, trading of CO2 allowances on a voluntary basis under two pilot trading programs began in Canada several years ago. Denmark has a CO2 reduction program which provides for allowance trading, and the UK has two voluntary programs. Norway will start a CO2 allowance trading program in 2008, and Sweden has a planned program due to start in 2005. Holland is developing a NOx trading program, and Slovakia has a SO2 allowance trading program.

In addition to obtaining allowances via emissions trading, an entity may comply with environmental regulations pertaining to a pollutant (e.g., NOx or SO2) in a variety of other ways. For example, the entity may reduce its emissions by:

1. Shutting down all or part of the facilities at a point source;

2. Modifying or curtailing production and/or operating hours of all or part of the facilities at a point source;

3. Improving control measures (e.g., lowering emission rates through fuel changes, technology improvements, such as improved controls/instrumentation, etc.);

4. Installing remediation equipment at the point source;

5. Making process changes that reduce emissions (e.g., making operational changes effecting efficiency and/or combustion conditions);

6. Relocating one or more point sources outside the region;

7. Purchasing a new point source(s) in the region that meets the environmental regulations; and

8. Trading allowances.

The actions or mechanisms listed above (1-8) are referred to as regulation compliance mechanisms (RCMs) herein. The listed RCMs are not necessarily all inclusive of the means for entities to comply with environmental regulations, as persons skilled in the art may determine other means, mechanisms, or actions which could enable a particular entity to comply with environmental regulations at a particular point source within a particular region.

The RCMs provide owners of sources such as power plants with options for reducing the emission rate of pollutants in order to comply with environmental regulations. For example, the rate of emission of the pollutants from a power plant can be reduced by reducing the overall power output of the plant, and thus the pollutant output, by planned outages and/or by purchasing power from elsewhere. Emission of sulfurous compounds such as SO2 can be reduced by using gas scrubbers and/or by changing fuels from high-sulfur coal to low-sulfur coal or oil. Emission of nitrogen oxides (NOx) can also be mitigated by operational changes affecting efficiency and/or combustion conditions of the power plant, by changing fuel types, and by installing Selective Catalytic Reduction (SCR) equipment. Increasing the proportion of air to fuel can help mitigate CO emissions. The emission of CO2 also can be reduced by increasing the efficiency of the power generation process such that less fuel has to be burned for each megawatt of electricity generated. The efficiency of the power generation process can be increased by using technologies such as cogeneration and waste heat recovery.

Methods and systems have been formulated to assist owners and operators of power plants and other sources to determine the optimum pollution control strategy for their facilities using information available to them. For example, U.S. patent application Publication No. 2002/0065581 A1 (Fasca) discloses a management tool that reportedly allows an electric utility manager to forecast the company's profit for every available strategy and combination of strategies for complying with the limits on pollutant emissions, and then to select the pollution control scheme that yields the maximum profit to the utility. Fasca's system uses real time data to automatically update the input parameters to the decision making process and revise the forecasted outcomes for the various strategies considered. Fasca's management tool may also include an optimization module intended to automatically determine the profit maximizing strategy and outputs the result to the utility manager.

Fasca's management tool is implemented using a computer. The computer has communication capabilities which allow the computer to obtain real time data regarding a power plant's power output and pollutant emissions from remotely located sensors and/or control systems. The computer may also include communications links to the utility's administrative, financial, and archival computers in order to facilitate the inputting of historical and financial data that are needed to make projections or forecasts regarding energy production, profits or costs, and pollutant emissions. Fasca's system also includes one or more continuous emission monitors (CEMs) which are in constant communication with the computer.

FIG. 1 illustrates a typical environmental compliance decision model presently used by some entities to develop an environmental compliance strategy. The inputs needed for the model are based on the industry, the available remediation/control technology, and the environment. As shown in FIG. 1, each entity must consider industrial facilities economics, pollutant control technologies and control schemes, and the EPA/state environmental mechanisms, such as the compliance regulations, the entities cost vs. allowance inventories, and the allowance trading rules of the Mass Emission Cap & Trade (MECT). In developing an environmental compliance strategy, the entity considers plant economics (e.g., production and tradeoffs), remediation technologies and the associated costs, and possible trades through the MECT to buy and/or sell allowances. With regard to trades through the MECT, the variables of price/risk, supply and demand, and the selection of brokers (for facilitating the purchase and/or sale of allowances) all need to be considered.

With regard to trades through the MECT, the environmental regulations allow for a mass emission cap and trade market or exchange that permits an entity to sell its allowances to another entity if the first entity is able to “free up” allowances. Individual brokers can approach particular entities and attempt to negotiate a sale of allowances to another entity for a commission. However, the activities of the brokers are not based on market forces. There is no way for the entities attempting to sell or buy allowances to appreciate the value of the allowances bought or sold at an industry level other than to consider what the selling party is willing to sell the allowances for or what the acquiring party is willing to pay.

At present, entities are developing and implementing sub optimum environmental compliance strategies through trading allowances or the other regulation compliance mechanisms (RCMs) previously discussed—either alone or in combination with other RCMs. There remains a need for a further optimization step that can be obtained at the industry wide level where entities through the use of an industry wide optimization model can increase the value of their compliance strategies by evaluating additional options to assist in complying with the applicable environmental regulations. At present, although the goal of each entity may be to comply in the most economical way possible, there is no incentive for entities in a non-attainment area to share information with other entities in the region in determining the best strategy for compliance. Economies of scale on remediation technologies are limited to the parameters within an entity and bear an increased risk with bringing these technologies to the market place using MECT, which is currently an illiquid clearinghouse of emission trading. Also, because there is no liquid market for allowances that provides entities with the true value of allowances available in a region at any point in time, the entities in the region are not able to optimize their strategies by an evaluation of all of the RCMs and/or combinations of RCMs available to them.

It is desired to have a method and system for one or more entities in a geographic region to comply with an environmental regulation by having better knowledge through the assimilation of fragmented data sources into one information system to create an industry-wide database that facilitates communication of allowance values at any period of time so entities can communicate these values at lower risk at the industry level. This will provide liquidity in the allowance trading market so that the entities can incorporate allowance trading as an integral part of their compliance strategy.

It is further desired to have a method and system for enabling one or more entities in a geographic region to comply with an environmental regulation which aggregate data and determine an optimal solution at an industry level through better use of the allowance trading market to achieve the liquidity needed to optimize.

It is still further desired to have a method and system for enabling one or more entities in a geographic region to comply with an environmental regulation which encourage the entities in a non-attainment area to share data and information in a manner that does not impede competition between the entities.

It also is desired to have a system and method for enabling one or more entities in a geographic region to comply with an environmental regulation which enable two or more of the entities in the region to establish, in the most cost effective manner, a way to meet their commercial objectives while complying with the environmental regulation.

### BRIEF SUMMARY OF THE INVENTION

The present invention is a method and system for enabling an entity of a group of entities in a region to comply with a regulation regarding a pollutant to be discharged in the region from a point source operated by an entity. The invention also includes a method for complying with a regulation regarding a pollutant discharged in the region from a point source operated by an entity during a designated period of time.

A first embodiment of the method for enabling an entity of a group comprising a plurality of entities located in a geographic region to comply with an environmental regulation regarding a pollutant to be discharged in a geographic region from at least one point source operated by at least one entity includes multiple steps. The first step is to establish an administrator in communication with at least two of the entities of the group. The second step is to establish an amount of discharge of the pollutant from the at least one point source operated by a first entity within the geographic region during a designated period of time. The third step is to compare the amount of discharge of pollutant from the at least one point source operated by the first entity within the geographic region during the designated period of time and an amount of allowance allocated to the first entity during the designated period of time to assess compliance of the first entity with the environmental regulation. The fourth step is to establish a value for the amount of allowance to be allocated by the first entity to discharge the pollutant from the at least one point source operated by the first entity within the geographic region during the designated period of time. The fifth step is to communicate the value established in the fourth step to the administrator or to a second entity. The sixth step is to define a solution enabling the first entity of the group to comply with the environmental regulation, wherein the solution compares the value established in the fourth step and a value for an amount of allowance to be allocated by the second entity to discharge the pollutant within the geographic region during the designated period of time.

There are several variations of the first embodiment of the method discussed above. In one variation, at least a portion of the group is a subscribership. In a variant of that variation, at least one of the entities of the group is a subscriber of the subscribership.

In another variation, the designated period of time is about one year. In yet another variation, the designated period of time is less than one year. In still yet another variation, the designated period of time is a number of years within a range of about one year to perpetuity.

In another variation, the amount of allowance allocated to the first entity during the designated period of time is equal to the amount of discharge of the pollutant from the at least one point source operated by the first entity within the geographic region during the designated period of time. In yet another variation, the amount of allowance allocated to the first entity during the designated period of time is greater than the amount of discharge of the pollutant from the at least one point source operated by the first entity within the geographic region during the designated period of time. In still yet another variation, the amount of the allowance allocated to the first entity during the designated period of time is less than the amount of discharge of the pollutant from the at least one point source operated by the first entity within the geographic region during the designated period of time.

In another variation, the amount of allowance allocated to the first entity during the designated period of time is equal to a total of the amount of discharge of the pollutant from all point sources operated by the first entity within a geographic region during the designated period of time. In yet another variation, the amount of allowance allocated to the first entity during the designated period of time is greater than a total of the amount of discharge of the pollutant from all point sources operated by the first entity within the geographic region during the designated period of time. In still yet another variation, the amount of allowance allocated to the first entity during the designated period of time is less than a total of the amount of discharge of the pollutant from all point sources operated by the first entity within the geographic region during the designated period of time.

A second embodiment of the method discussed above is similar to the first embodiment but includes a seventh step of implementing the solution defined in the sixth step of the first embodiment. In a variation of the second embodiment, the seventh step includes a sub-step of transferring from the second entity to the first entity at least a portion of the amount of allowance allocated to the second entity.

A variation of the second embodiment of the method includes several additional steps—eighth, ninth, tenth, eleventh, and twelfth steps. The eighth step is to update the amount of discharge of the pollutant from the at least one point source operated by at least one entity within the geographic region during the designated period of time or another period of time and the amount of allowance allocated to each entity during the designated period of time or the another designated period of time. The ninth step is to compare the amount of discharge of the pollutant from the at least one point source operated by one of the first entity, or the second entity, or another entity within the geographic region during the designated period of time or the another designated period of time and the amount of allowance allocated to the one of the first entity, or the second entity, or the another entity during the designated period of time or the another designated period of time to assess compliance with the one of the first entity, or the second entity, or the another entity with the environmental regulation. The tenth step is to establish a value for the amount of allowance to be allocated by the one of the first entity, or the second entity, or the another entity to discharge the pollutant from the at least one point source within the geographic region during the designated period of time or the another designated period of time. The eleventh step is to communicate the value established in the tenth step to the administrator or to one of the first entity, or the second entity, or the another entity. The twelfth step is to define a solution enabling one of the first entity, or the second entity, or the another entity to comply with the environmental regulation, wherein the solution compares the value established in the tenth step and a value for an amount of allowance to be allocated by a selected entity of the group to discharge the pollutant within the geographic region during the designated period of time or the another designated period of time.

A variant of the variation discussed in the above paragraph includes a thirteenth step of implementing the solution defined in the twelfth step. In a variant of that variant, the thirteenth step includes the sub-step of transferring from the selected entity to the one of the first entity, or the second entity, or the another entity at least a portion of the amount of allowance allocated to the selected entity.

Another variation of the second embodiment includes two additional steps—fourteenth and fifteenth steps. The fourteenth step is to update the amount of discharge of the pollutant from the at least one point source operated by at least one entity with in the geographic region during the designated period of time or another designated period of time and the amount of allowance allocated to each entity during the designated period of time or the another designated period of time. The fifteenth step is to repeat the steps from the tenth step through the thirteenth step.

A third embodiment of the method discussed above includes multiple steps. The first step is to establish an administrator in communication with at least two of the entities of the group. The second step is to establish an amount of discharge of pollutant from the at least one point source operated by a first entity within the geographic region during a designated period of time, wherein the designated period of time is a number of years within a range from less than about one year to perpetuity. The third step is to compare the amount of discharge of the pollutant from the at least one point source operated by the first entity within the geographic region during the designated period of time and an amount of allowance allocated to the first entity during the designated period of time to assess compliance of the first entity with the environmental regulation. The fourth step is to establish a value for the amount of allowance to be allocated by the first entity to discharge the pollutant from the at least one point source operated by the first entity within the geographic region during the designated period of time. The fifth step is to communicate the value established in the fourth step to the administrator or to a second entity. The sixth step is to define a solution enabling the first entity of the group to comply with the environmental regulation, wherein the solution compares the value established in the fourth step and a value for an amount of allowance to be allocated by the second entity to discharge the pollutant within the geographic region during the designated period of time. The seventh step is to transfer from the second entity to the first entity at least a portion of the amount of allowance allocated to the second entity. The eighth step is to update the amount of discharge from the pollutant to the at least one point source operated by at least one entity within the geographic region during the designated period of time or another designated period of time and the amount of allowance allocated to each entity during the designated period of time or the another designated period of time. The ninth step is to compare an amount of discharge of the pollutant from the at least one point source operated by one of the first subscriber, or the second subscriber, or another subscriber within the geographic region during the designated period of time or the another designated period of time and the amount of allowance allocated to the one of the first entity, or the second entity, or the another entity during the designated period of time or the another designated period of time to assess compliance of the one of the first entity, or the second entity, or the another entity with the environmental regulation. The tenth step is to establish a value for the amount of allowance to be allocated by the one of the first entity, or the second entity, or the another entity to discharge the pollutant from the at least one point source within the geographic region during the designated period of time or the another designated period of time. The eleventh step is to communicate the value established in the tenth step to the administrator or to the one of the first entity, or the second entity, or the another entity. The twelfth step is to define a solution enabling the one of the first entity, or the second entity, or the another entity to comply with the environmental regulation, wherein the solution compares the value established in the tenth step and a value for an amount of allowance to be allocated by a second entity of the group to discharge the pollutant within the geographic during the designated period of time or the another designated period of time. The thirteenth step is to transfer from the selected entity to the one of the first entity, or the second entity, or the another entity at least a portion of the amount of allowance allocated to the selected entity. The fourteenth step is to update the amount of discharge of the pollutant from the at least one point source operated by at least one entity within the geographic region during the designated period of time or the another designated period of time and the amount of allowance allocated to each entity during the designated period of time or the another designated period of time. The fifteenth step is to repeat the steps from the tenth step through the thirteenth step.

Another aspect of the present invention is a subscribership comprising a plurality of entities located in a geographic region utilizing any one of the embodiments or variations of the method discussed above for enabling at least one of the entities to comply with an environmental regulation regarding a pollutant to be discharged in the geographic region from at least one point source operated by at least one of the entities during a designated period of time.

The present invention also includes a method for complying with an environmental regulation regarding a pollutant to be discharged in a geographic region from at least one point source operated by at least one entity during a designated period of time. This method includes multiple steps. The first step is to establish an administrator and a subscribership in communication with the administrator, the subscribership including a plurality of entities, at least one of the entities operating the at least one point source in the geographic region. The second step is to establish an amount of discharge of the pollutant from the at least one point source operated by a first entity within the geographic region during a designated period of time. The third step is to compare the amount of discharge of the pollutant from the at least one point source operated by the first entity within the geographic region during the designated period of time and an amount of allowance allocated to the first entity during the designated period of time to assess compliance of the first entity with the environmental regulation. The fourth step is to establish a value for the amount of allowance to be allocated by the first entity to discharge the pollutant from the at least one point source operated by the first entity within the geographic region during the designated period of time. The fifth step is to communicate the value established in the fourth step to the administrator or to the second entity. The sixth step is to define a solution enabling the first entity of the subscribership to comply with the environmental regulation, wherein the solution compares the value established in the fourth step and a value for an amount of allowance to be allocated by the second entity to discharge the pollutant within a geographic region during the designated period of time. The seventh step is to implement the solution defined in the sixth step.

In addition, the present invention includes a system for enabling an entity of a group comprising a plurality of entities located in a geographic region to comply with an environmental regulation regarding a pollutant to be discharged in the geographic region from at least one point source operated by at least one entity. A first embodiment of the system includes multiple elements. The first element is an administrator in communication with at least two of the entities of the group. The second element is a means for establishing an amount of discharge of the pollutant from the at least one point source operated by a first entity for the geographic region during a designated period of time. The third element is a means for comparing the amount of discharge of the pollutant from the at least one point source operated by the first entity within the geographic region during the designated period of time and an amount of allowance allocated to the first entity during the designated period of time to assess compliance of the first entity with the environmental regulation. The fourth element is a means for establishing a value for the amount of allowance to be allocated by the first entity to discharge the pollutant from the at least one point source operated by the first entity within the geographic region during the designated period of time. The fifth element is a means for communicating the value established in the fourth element to the administrator or to a second entity. The sixth element is a means for defining a solution enabling the first entity of the group to comply with the environmental regulation, wherein the solution compares the value established in the fourth element and a value for an amount of allowance to be allocated by the second entity to discharge the pollutant within the geographic region during the designated period of time.

There are several variations of the first embodiment of the system. In one variation, at least a portion of the group is a subscribership. In a variant of that variation, at least one of the entities of the group is a subscriber of the subscribership.

A second embodiment of the system is similar to the first embodiment of the system but includes as a seventh element a means for implementing the solution defined in the sixth element.

### BRIEF DESCRIPTION OF SEVERAL VIEWS OF THE DRAWINGS

The invention will be described by way of example with reference to the accompanying drawings, in which:

FIG. 1 is a diagram illustrating a typical environmental compliance decision model presently used by some entities to develop an environmental compliance strategy;

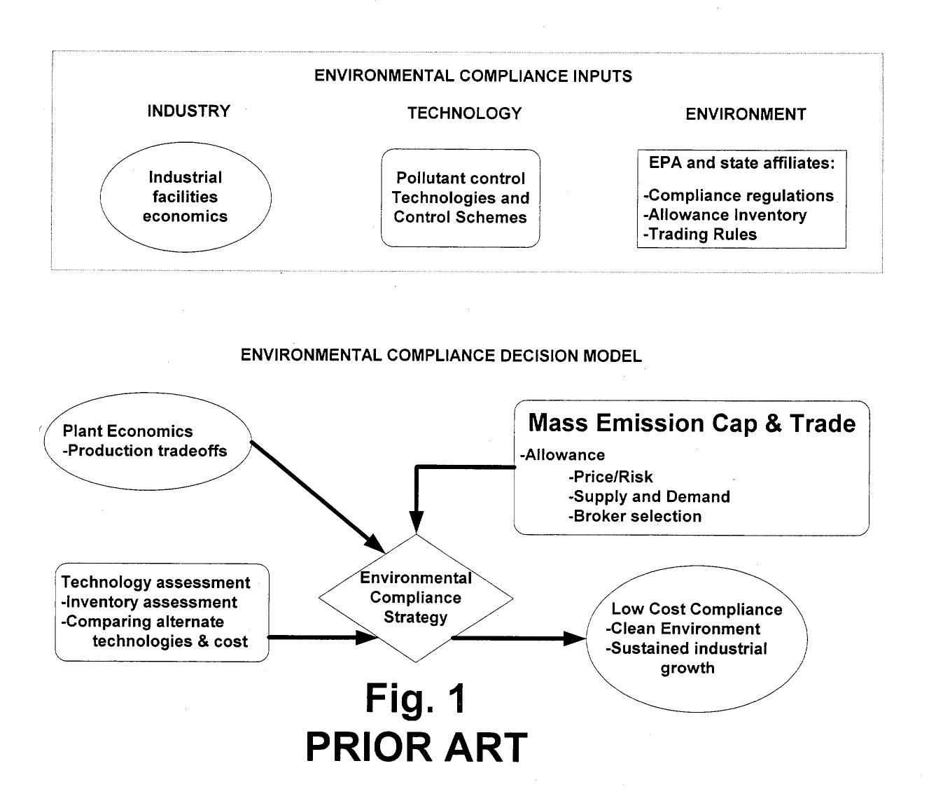

FIG. 2 is a schematic diagram of a non-attainment region having multiple entities with one or more point sources wherein some, but not all, of the entities are subscribers to a subscribership according to the present invention;

FIG. 3 is a schematic diagram illustrating the flow of different types of data and compliance strategies between an administrator and subscribers according to the present invention;

FIG. 4 is a block-flow diagram of one embodiment of the present invention;

FIG. 5 is a schematic diagram illustrating the aggregation of facility allowances and point source allowances for a subscriber/entity;

FIG. 6 is a block diagram illustrating the inputs and outputs of the optimization equations and processing used in the method of the present invention; and

FIG. 7 is a schematic diagram illustrating one embodiment of the present invention.

### DETAILED DESCRIPTION OF THE INVENTION

The present invention improves the way in which a group of entities, all subject to the same environmental regulations, can meet their compliance obligations through the use of a method to optimize the engineering, operational, and financial approaches for attaining environmental compliance. This method results in improved environmental compliance at reduced cost and greater operational flexibility in a non-attainment region. Although some steps of the method may already be carried out at the level of a single entity, aggregating data and carrying the solution out at the “industry level” enables a superior solution to be obtained through better use of the aggregated data and the allowance trading functionality built into the environmental regulations. The method of the present invention achieves the necessary liquidity in the allowance trading area to optimize the industry response to regulatory demands.

As used herein, the term “region” is intended to cover any non-attainment area wherein entities are subject to the same environmental regulations. A non-attainment area is a geographic area shown by monitored data or modeling to exceed the NAAQS for a particular air pollutant. A single geographic area may have acceptable levels of one criteria air pollutant but unacceptable levels of one or more other criteria air pollutants, and thus, can be both in attainment and in non-attainment at the same time. (Criteria air pollutants are air pollutants regulated by the EPA on the basis of criteria—information on health and environmental effects of pollution; criteria air pollutants include nitrogen oxides, sulfur oxides and particulates.) An airshed, a county, counties, state(s), country, countries, continent(s), etc. are all possible regions, and the term “region” is not limited to any specific area in the United States or in the world.

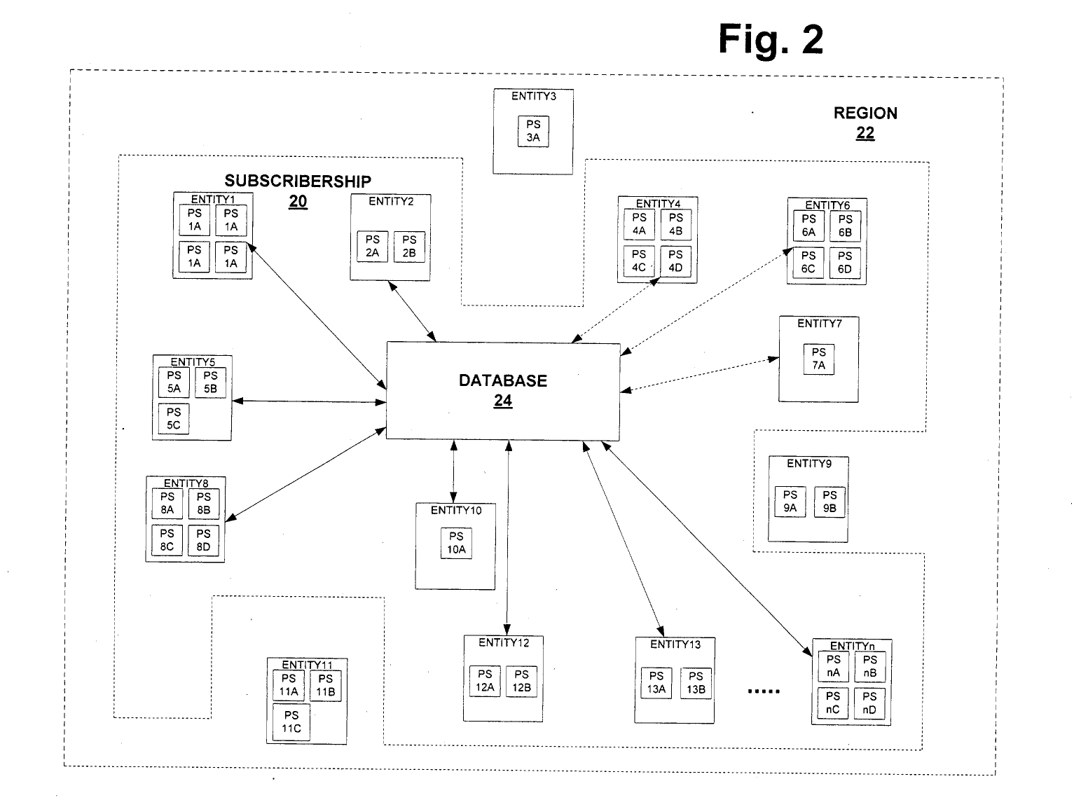

As shown in FIG. 2, the method of the present invention involves the establishment of a subscribership 20 of entities in a non-attainment region 22 in which all of the entities are subject to the same environmental regulations. Each entity operates at least one point source (PS) that emits at least one pollutant (e.g., SO2, NOₓ, etc.) into the environment of the non-attainment region 22.

Membership in the subscribership 20 requires that each entity convey data related to the emissions from its respective point sources on a time basis that is at least as frequent as the time basis required by the environmental regulations. In one embodiment, the subscribership 20 utilizes a centralized electronic database 24 administered by an administrator, and the preferred time basis is near real time conveyance of data to the database 24. However, the present invention may include an automated collection of emissions data using an electronic database 24, including polling the various entities, or any other manner of automatically collecting such emissions data known in the art, as well as any less preferred manner of collecting such emissions data, including manual means (e.g., submission of emissions data reports to the subscribership 20 on a regular basis). A key feature is the conveyance of such emissions data from each subscriber on a time basis at least as frequent as that required by the environmental regulations.

The data conveyed to the electronic database 24 (or whatever means is used to store such data) from each subscriber is held in confidence such that no subscriber can obtain the data related to another subscriber. Only the administrator is privy to the data of the individual subscribers.

Preferably, the subscribership 20 includes every entity in the non-attainment region 22 that emits the pollutant(s) subject to the applicable environmental regulations. However, there may be entities that choose not to subscribe. For example, as shown in FIG. 2, entities 3, 9 and 11 have chosen not to participate in the subscribership 20, although they are located in the non-attainment region 22.

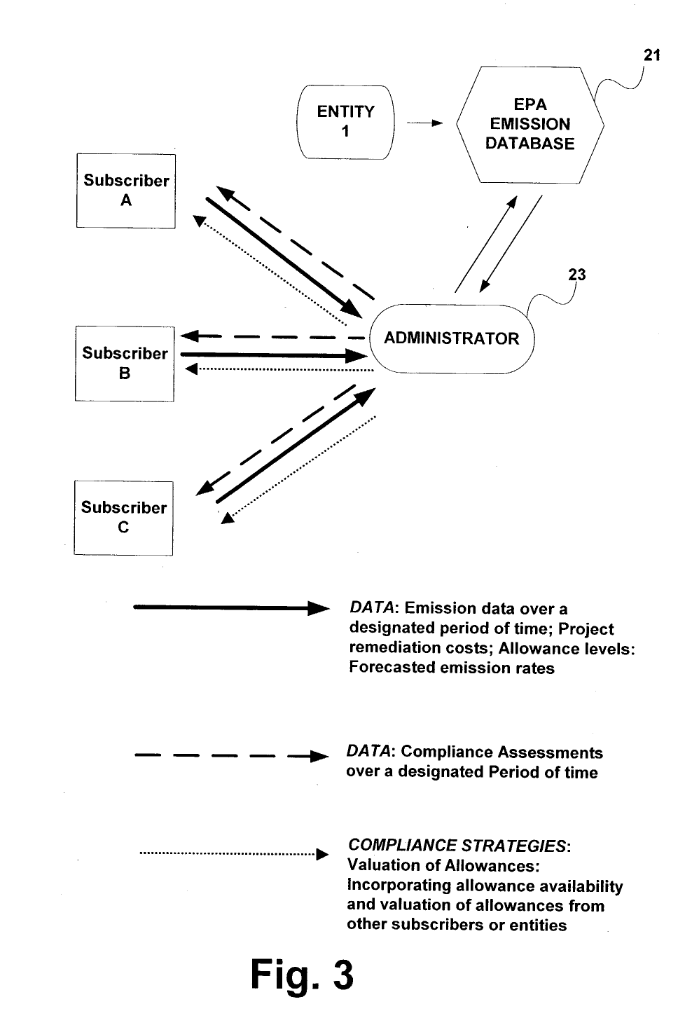

The term “emissions data” as used herein includes environmental performance data from relevant sensors or customer control systems, as well as data on future production and forecasted emission rates. The broader term “data” as used herein includes, in addition to emissions data over a designated period of time, project remediation costs, allowance levels, and compliance assessments over a designated period of time. In the context of the present invention, certain data are communicated to and from the administrator and the subscribers of the subscribership, as shown in FIG. 3.

The subscribership in FIG. 3 comprises three entities—subscriber A, subscriber B, and subscriber C. A fourth entity, entity 1, represents an entity which is not a subscriber and which is located inside the non-attainment region where subscribers A, B, and C are located. Entity 1 communicates emission data directly to the EPA emission database 21 at a time period established by the EPA, while the administrator 23 communicates with the EPA emission database on behalf of subscribers A, B, and C. As shown in FIG. 3, these subscribers (A, B, and C) communicate data to the administrator in the form of emission data over a designated period of time, project remediation costs, allowance levels, and forecasted emission rates. The administrator communicates data in the form of compliance assessments over a designated period of time to each of the subscribers and also communicates compliance strategies to subscribers. The compliance strategies detail compliance solutions that incorporate the value of allowances and their availability from other entities and how these alternative valuation schemes can provide lower cost compliance solutions.

Where an electronic database 24 is used in the subscribership 20, each entity can convey emissions data either directly or indirectly. Direct conveyance is achieved by monitoring the emissions of each point source directly. Indirect conveyance is achieved by utilizing product production data (e.g., amount of product created, size of reactor, reaction time, etc.) which is used to calculate the amount of the pollutant(s) being emitted. The calculated emissions data is then conveyed to the electronic database 24.

Under the CAAA, continuous emission monitoring system (CEMS) equipment is required to sample, analyze, measure and record emissions, flow and other parameters continuously. With regard to the present invention, CEMS equipment may be used to gather and transmit emission data from subscribers to the administrator.

The following are CEMS software packages that can be used in the present invention and are by way of example only: Environmental Portfolio Manager by Pavillion; Air Track by ENSR International; Enviance® by Enviance; Edicts by Envirochem; Fingerprint Environmental Software by Environmental Management & Compliance; Enviro 2000 by Envitech Ltd.; EMIS (Enverdant) by ERM; Emission Reporting System by P3Msoftware; NetDAHS-KVB Enertec by GE; Compliance Intelligent by Common Vision; Essential EH&S by Environmental Support Solutions; EcoAsset by ESP.net; New Leaf® Software by CadhamHaves Syster; Gemtrack by Gemteck Environment; ENVINET by Technidata AG; and CEMs/DAS/RTU by Wondermation.

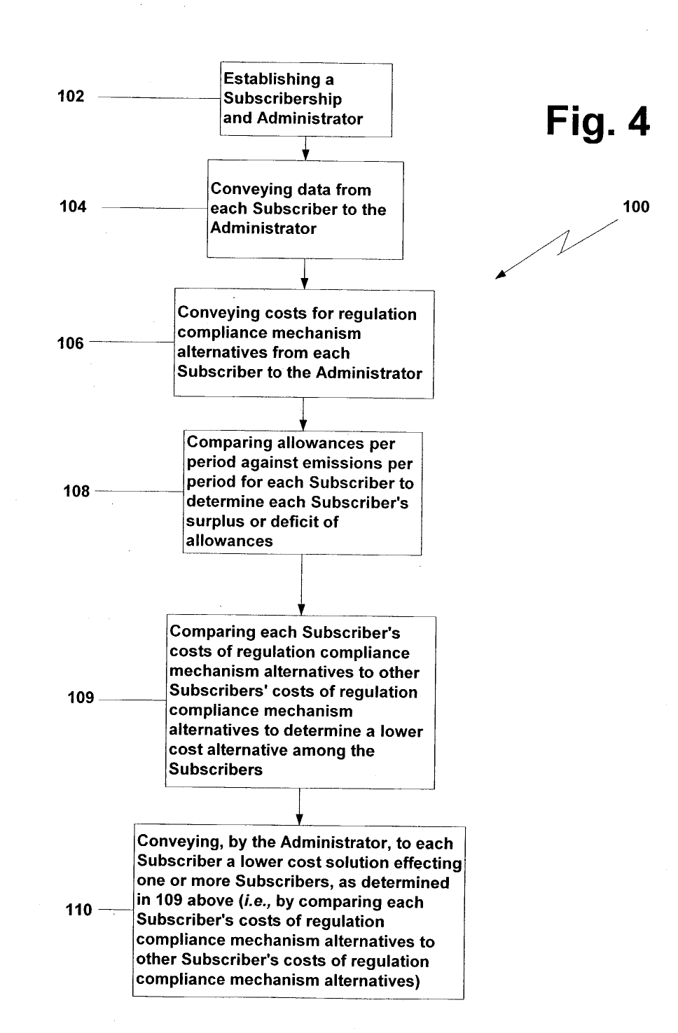

FIG. 4 is a block-flow diagram illustrating one embodiment of a multi-step method 100 of the present invention. The first step 102 establishes a subscribership and an administrator as previously discussed. In the second step 104, data is conveyed from each subscriber to the administrator as previously discussed. Step 106 involves conveying costs for regulation compliance mechanism (RCM) alternatives from each subscriber to the administrator. As discussed in the Background of The Invention, the RCMs may include:

1. Shutting down all or part of the facilities at a point source;

2. Modifying or curtailing production and/or operating hours of all or part of the facilities at a point source;

3. Improving control measures (e.g., lowering emission rates through fuel changes, technology improvements, such as improved controls/instrumentation, etc.);

4. Installing remediation equipment at the point source;

5. Making process changes that reduce emissions (e.g., making operational changes effecting efficiency and/or combustion conditions);

6. Relocating one or more point sources outside the region;

7. Purchasing a new point source(s) in the region that meets the environmental regulations; and

8. Trading allowances.

The fourth step 108 of the method 100 requires that each entity determine whether or not its emissions during a certain period (e.g., a year) exceed the allowances allocated to the entity for that same period. This determination can be conducted by the entity itself or by the administrator.

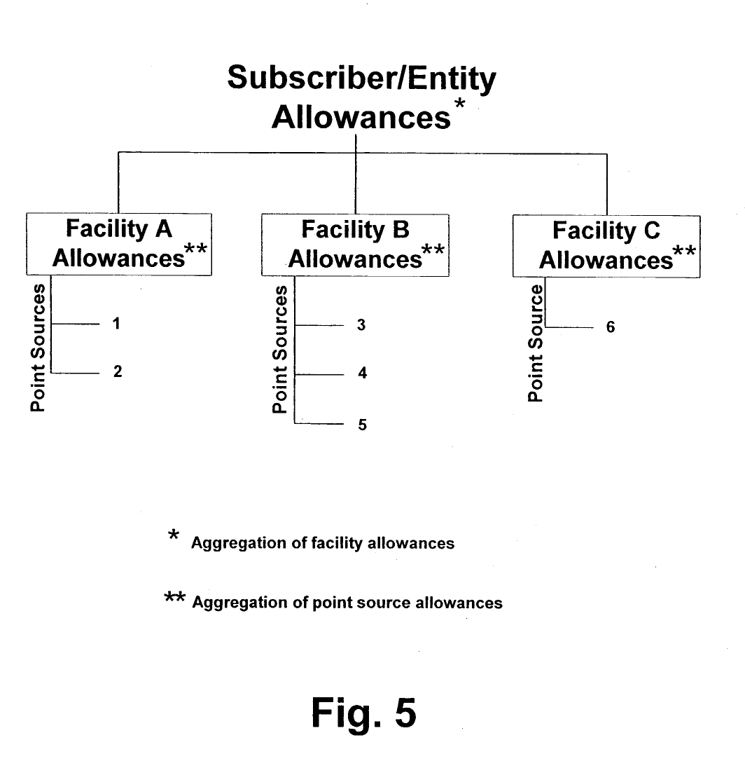

As shown in FIG. 5, a subscriber may be an entity having one or more facilities (sites) with each facility having one or more point sources “operated” by the entity. (As used herein, the term “operated” includes “owned, leased, operated or otherwise controlled” by the entity.) Allowances are allocated at the point source level and may be aggregated at the facility (site) level, and the facility (site) allowances may be aggreted at the entity level. Allowances may be traded between facilities (sites) to achieve compliance.

Once the allowance surplus or deficit of each subscriber is known, the administrator determines the cost to remediate versus the amount (e.g., tonnage) of emission of the pollutant (e.g., SO2, NOₓ, etc.) that can be removed. This varies for each subscriber and the particulars of each point source operation, size, etc., as well as the specifics of the various available remediation technologies and their associated costs.

After the administrator has determined the costs for each of the subscribers, the optimization can be achieved at step 109 in FIG. 4. The present invention allows all of the subscribers in the subscribership 20 to better value each of the RCMs in making a decision as to how most efficiently meet the regulations while minimizing the costs involved. Introducing economics of allowance in advance of allowance creating capital projections reduces the speculative risk from both seller and buyer. By allowing subscribers to value and weigh the RCMs, the subscribership 20 induces certain subscribers to sell allowances that other subscribers are willing to pay for when it is in their best interest to do so. The subscribership 20 allows each subscriber to readily evaluate the RCMs at any time and to have a sense of the value of allowance credits, whether that subscriber wants to buy or sell his/her allowance credits.

In step 109, the administrator “assesses” all of this information, i.e., the costs, the allowance surplus/deficits, the various remediation technologies and their associated costs, etc., and is able to propose to one or more subscribers in step 110 a lower cost solution based on the valuation of the various RCMs from each of the subscribers. A proposal to a subscriber shows the values of various solutions that match best various subscribers' strategies using this method. Thus, the subscriber is able to assess the relative value of knowing what it can achieve knowing the “industry” information available from the subscribership.

In making the “assessment” in step 109, the administrator “assesses compliance” of an entity or subscriber. As used herein, the term “assess compliance” is intended to include not only a determination of whether an entity has a surplus or deficit of allowances, but also a determination of costs for scenarios where the entity may: (1) under-control and buy allowances, (2) emit a lesser amount of pollutant than allowed, (3) over-control and sell allowances, (4) use a mixture of controls and acquisitions of allowances, or (5) curtail operations on a schedule that is parallel with the entity's declining emissions budget for the non-attainment region.

Each subscriber may pick when it wants to act on the proposals by buying allowances, selling allowances, installing remediation equipment, etc. This makes timing very important and requires updating the information before rerunning the method to reflect new data, the addition or deletion of subscribers, changes in the market, regulatory changes, technology advancements, plant expansions, shutdowns, operating changes, etc.

For example, the administrator may determine that Entity 1, if it overcontrols one of its point sources (i.e., implement RCM 1 above), is able to offer Entity 7 allowances (i.e., implement RCM 8 above) to emit 40 tons, at a rate that is less costly to Entity 7 than if Entity 7 had purchased or implemented remediation equipment to remove that 40 tons. Moreover, Entity 1 may be able to make a profit by selling these two allowances to Entity 7 even though Entity 1 had to overcontrol one of its point sources. Thus, the method of the present invention allows the administrator to provide superior solutions to the subscribership through the identification and communication of the lowest cost of allowance gained from receiving industry data from the subscribership that are not readily apparent if the subscribership 20 did not exist. In other words, Entity 1 would have had no incentive to overcontrol one of its point sources but for the administrator's proposal to do so. And even if Entity 1 would have overcontrolled its point source to simply free up allowances for sale, there is a speculative risk that a seller bears due to the uncertainty regarding allowance pricing caused by illiquidity of the market for allowances. Furthermore, because the administrator can “see” the near real time position of each subscriber in the region 22 with regard to its respective costs and allowance surpluses or deficits, the values of allowances that can be traded are based on the economics of the project(s) and are not speculative. Moreover, the subscribership 20 allows the administrator to act as a broker of “multiple RCMs” rather than just as an allowance trading broker.

Another example of how the method allows each subscriber to value the RCMs can be illustrated using hypothetical data for Entity n. Entity n needs to remove 100 tons of NOₓ by the end of the year, and Entity n knows that to eliminate 100 tons on its own will cost approximately $500,000 or $5,000/ton. Thus, if Entity n cannot purchase allowances at a rate less than $5,000/ton, it is better for Entity n to conduct remediation. However, if there is an entity (or entities) in the region 22 willing to sell allowances at a rate less than $5,000/ton, Entity n may consider purchasing allowances, rather than implementing the remediation on its own. Allowance pricing, future allowance availability, and regulatory changes are current inherent risks that inhibit these transactions from occurring more frequently given the existing market structure.

Another example of how the method allows for each subscriber to value the RCMs can be illustrated using the data with regard to Entity n above. Assume Entity n has 25 tons to remediate. This can be achieved using the following RCMs:

a) remove 25 tons @$9,000/ton for $225,000;

b) remove 50 tons @$8,000/ton for $400,000 and sell the extra 25 tons for ($400,000−225,000)=$7,000/ton or greater

c) similar to option (b) but selling 75 tons extra from controlling at a 100 ton source (PSnC) for ($500,000−225,000)=$3,666/ton or greater.

After identifying the cost effective RCMs and presenting proposals to the subscribers, the administrator may or may not implement the RCMs. It is up to the individual subscribers to act on the proposals. Alternatively, if a particular entity authorizes the administrator to act, the administrator can manage the implementation of an emissions reduction project. Thus, through the method of the present invention, the administrator develops proposed solutions for each subscriber which allows the subscribers to weigh the choices of RCMs in deciding the most economical way to comply with environmental regulations at any moment in time.

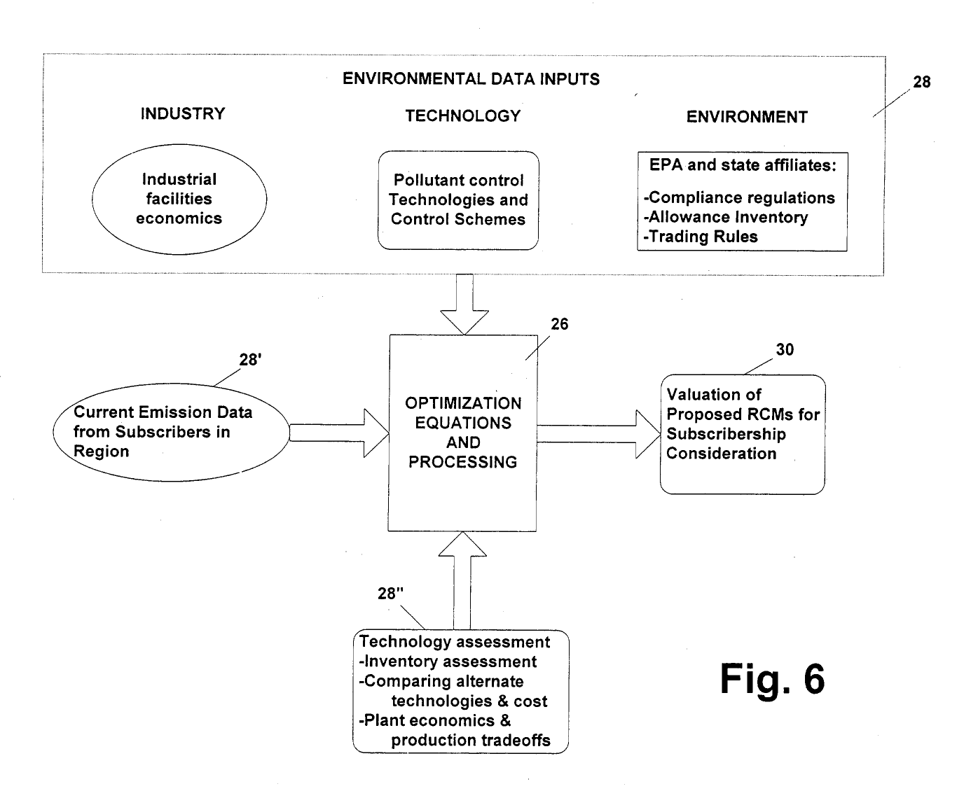

To carry out step 109 in FIG. 4, the administrator, as shown in FIG. 6, uses optimization equations 26, which are complex relationships (e.g., using mixed integer linear programming) that represent the total cost of remediation (i.e., all technologies available and known for emission reduction and their alternatives) and the current and projected emission and allowance levels for the non-attainment region 22. One example of linear programming software that is commercially available is C-Plex. An available modeling platform that may be used is General Algebraic Modeling System (GAMS). Equation solvers/curve-fitting engines (e.g., Microsoft Excel Solver, etc.) are used to determine what parameters minimize the total cost of remediation for the region 22. The solutions that are presented to the subscribers in terms of valuations of proposed RCMs are shown as output 30 in FIG. 6, which shows the inputs (28, 28′, 28″) and the output 30 of the optimization equations (OEP) 26 and processing of the method.

The electronic database 24 includes a detailed information bank of environmental-related material that is used by the administrator and the OEP 26. Besides providing the valuation of the RCMs as the output 30 of the OEP 26, the electronic database 24 also may support, among other things, handling allowance purchasing/selling within the subscribership 20, a detailed listing of engineering resources for execution of emission reduction projects, requisite means for effecting the electronic filing of necessary reports with environmental agencies, a repository of scientific research data on emissions status, etc. In addition, the administrator can perform assessment studies and provide recommendations that optimize operating conditions such as shutdowns and peaking production to the allowable permit levels.

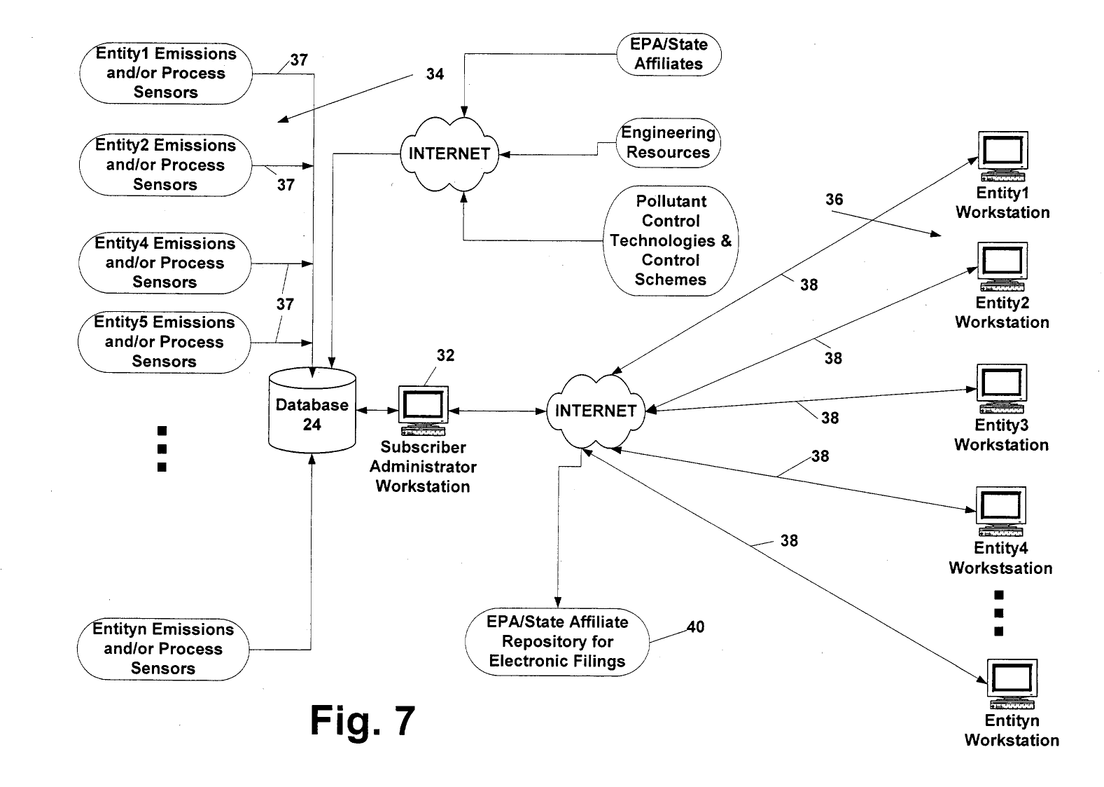

FIG. 7 shows one embodiment of a system implementing the method of the present invention, which includes the electronic database 24, an administrator workstation 32, subscriber emissions and/or process sensors 34, and subscriber workstations 36. In particular, the subscriber emissions and/or process sensors (e.g., remote terminal units (RTUs)) 34 correspond to the conveyance of emissions data, either directly or indirectly, over secure data lines 37 to maintain the confidentiality of this data. In addition, the electronic database 24 is updated as to EPA/State affiliate related material (e.g., regulations, allowance inventories, allowance trading rules, etc.), engineering resource details, and pollutant control technologies and control schemes via the Internet. As a result, the electronic database 24 reflects the most current environmental-related information, both as to subscriber-specific data and as to environmental technology and legal requirement data, all of which are necessary for the proper determination of the valuation of the RCMs.

The administrator workstation 32 permits the administrator to manage the electronic database 24 and to communicate with each of the subscribers at the subscriber workstations 36. The communication between the administrator workstation 32 and each individual subscriber workstation 36 is over the Internet using a secure connection 38. The secure connection 38 allows the administrator to receive from and transmit to the individual subscribers confidential data and information (e.g., proposed solutions) in a computer-compatible format. The administrator workstation 32 also enables the administrator to generate and electronically-file any EPA/State affiliate reports over the Internet to an EPA/State affiliate repository 40 in a timely manner.

The present invention is based on the premise that the subscribers and others in the region will benefit through the use of the method and system of the invention. This does not exist in the current environment. Moreover, the present invention induces subscribers to evaluate and reevaluate their situation even when they are in compliance.

The various embodiments of the present invention have been described with reference to the drawings and examples discussed above. However, it should be appreciated that variations and modifications may be made to those embodiments, drawings, and examples without departing from the spirit and scope of the invention as defined in the claims which follow.

1. A method for enabling an entity of a group comprising a plurality of entities located in a geographic region to comply with an environmental regulation regarding a pollutant to be discharged in the geographic region from at least one point source operated by at least one entity, comprising the steps of:
(a) establishing an administrator in communication with at least two of the entities of the group;
(b) establishing an amount of discharge of the pollutant from the at least one point source operated by a first entity within the geographic region during a designated period of time;
(c) comparing the amount of discharge of the pollutant from the at least one point source operated by the first entity within the geographic region during the designated period of time and an amount of allowance allocated to the first entity during the designated period of time to assess compliance of the first entity with the environmental regulation;
(d) establishing a value for the amount of allowance to be allocated by the first entity to discharge the pollutant from the at least one point source operated by the first entity within the geographic region during the designated period of time;
(e) communicating the value established in step (d) to the administrator or to a second entity; and
(f) defining a solution enabling the first entity of the group to comply with the environmental regulation, wherein the solution compares the value established in step (d) and a value for an amount of allowance to be allocated by the second entity to discharge the pollutant within the geographic region during the designated period of time.

2. The method of claim 1, wherein at least a portion of the group is a subscribership.

3. The method of claim 2, wherein at least one of the entities of the group is a subscriber of the subscribership.

4. A method as in claim 1, comprising the further step of:
(g) implementing the solution defined in step (f).

5. A method as in claim 4, comprising the further steps of:
(h) updating the amount of discharge of the pollutant from the at least one point source operated by at least one entity within the geographic region during the designated period of time or another designated period of time and the amount of allowance allocated to each entity during the designated period of time or the another designated period of time;
(i) comparing the amount of discharge of the pollutant from the at least one point source operated by one of the first entity, or the second entity, or another entity within the geographic region during the designated period of time or the another designated period of time and the amount of allowance allocated to the one of the first entity, or the second entity, or another entity during the designated period of time or the another designated period of time to assess compliance of the one of the first entity, or the second entity, or the another entity with the environmental regulation;
(j) establishing a value for the amount of allowance to be allocated by the one of the first entity, or the second entity, or the another entity to discharge the pollutant from the at least one point source within the geographic region during the designated period of time or another designated period of time;
(k) communicating the value established in step (j) to the administrator or to the one of the first entity, or the second entity, or the another entity; and
(l) defining a solution enabling the one of the first entity, or the second entity, or the another entity to comply with the environmental regulation, wherein the solution compares the value established in step (j) and a value for an amount of allowance to be allocated by a selected entity of the group to discharge the pollutant within the geographic region during the designated period of time or the another designated period of time.

6. A method as in claim 5, comprising the further step of:
(m) implementing the solution defined in step (l).

7. A method as in claim 6, comprising the further steps of:
(n) updating the amount of discharge of the pollutant from the at least one point source operated by at least one entity within the geographic region during the designated period of time or another designated period of time and the amount of allowance allocated to each entity during the designated period of time or the another designated period of time; and
(o) repeating steps (i) through (m).

8. The method of claim 1, wherein the designated period of time is about one year.

9. The method of claim 1, wherein the designated period of time is less than one year.

10. The method of claim 1, wherein the designated period of time is a number of years within a range from about one year to perpetuity.

11. The method of claim 4, wherein the step (g) of implementing the solution defined in step (f) comprises the sub-step of transferring from the second entity to the first entity at least a portion of the amount of allowance allocated to the second entity.

12. The method of claim 6, wherein the step (m) of implementing the solution defined in step (l) comprises the sub-step of transferring from the selected entity to the one of the first entity, or the second entity, or the another entity at least a portion of the amount of allowance allocated to the selected entity.

13. The method of claim 1, wherein the amount of allowance allocated to the first entity during the designated period of time is equal to the amount of discharge of the pollutant from the at least one point source operated by the first entity within the geographic region during the designated period of time.

14. The method of claim 1, wherein the amount of allowance allocated to the first entity during the designated period of time is greater than the amount of discharge of the pollutant from the at least one point source operated by the first entity within the geographic region during the designated period of time.

15. The method of claim 1, wherein the amount of the allowance allocated to the first entity during the designated period of time is less than the amount of discharge of the pollutant from the at least one point source operated by the first entity within the geographic region during the designated period of time.

16. The method of claim 1, wherein the amount of allowance allocated to the first entity during the designated period of time is equal to a total of the amount of discharge of the pollutant from all point sources operated by the first entity within the geographic region during the designated period of time.

17. The method of claim 1, wherein the amount of allowance allocated to the first entity during the designated period of time is greater than a total of the amount of discharge of the pollutant from all point sources operated by the first entity within the geographic region during the designated period of time.

18. The method of claim 1, wherein the amount of allowance allocated to the first entity during the designated period of time is less than a total of the amount of discharge of the pollutant from all point sources operated by the first entity within the geographic region during the designated period of time.

19. A method for enabling an entity of a group comprising a plurality of entities located in a geographic region to comply with an environmental regulation regarding a pollutant to be discharged in the geographic region from at least one point source operated by at least one entity, comprising the steps of:
(a) establishing an administrator in communication with at least two of the entities of the group;
(b) establishing an amount of discharge of the pollutant from the at least one point source operated by a first entity within the geographic region during a designated period of time, wherein the designated period of time is a number of years within a range from less than about one year to perpetuity;
(c) comparing the amount of discharge of the pollutant from the at least one point source operated by the first entity within the geographic region during the designated period of time and an amount of allowance allocated to the first entity during the designated period of time to assess compliance of the first entity with the environmental regulation;
(d) establishing a value for the amount of allowance to be allocated by the first entity to discharge the pollutant from the at least one point source operated by the first entity within the geographic region during the designated period of time;
(e) communicating the value established in step (d) to the administrator or to a second entity;
(f) defining a solution enabling the first entity of the group to comply with the environmental regulation, wherein the solution compares the value established in step (d) and a value for an amount of allowance to be allocated by the second entity to discharge the pollutant within the geographic region during the designated period of time;
(g) transferring from the second entity to the first entity at least a portion of the amount of allowance allocated to the second entity;
(h) updating the amount of discharge of the pollutant from the at least one point source operated by at least one entity within the geographic region during the designated period of time or another designated period of time and the amount of allowance allocated to each entity during the designated period of time or the another designated period of time;
(i) comparing the amount of discharge of the pollutant from the at least one point source operated by one of the first subscriber, or the second subscriber, or another subscriber within the geographic region during the designated period of time or the another designated period of time and the amount of allowance allocated to the one of the first entity, or the second entity, or another entity during the designated period of time or the another designated period of time to assess compliance of the one of the first entity, or the second entity, or the another entity with the environmental regulation;
(j) establishing a value for the amount of allowance to be allocated by the one of the first entity, or the second entity, or the another entity to discharge the pollutant from the at least one point source within the geographic region during the designated period of time or the another designated period of time;
(k) communicating the value established in step (j) to the administrator or to the one of the first entity, or the second entity, or the another entity;
(l) defining a solution enabling the one of the first entity, or the second entity, or the another entity to comply with the environmental regulation, wherein the solution compares the value established in step (j) and a value for an amount of allowance to be allocated by a selected entity of the group to discharge the pollutant within the geographic region during the designated period of time or the another designated period of time;
(m) transferring from the selected entity to the one of the first entity, or the second entity, or the another entity at least a portion of the amount of allowance allocated to the selected entity;
(n) updating the amount of discharge of the pollutant from the at least one point source operated by at least one entity within the geographic region during the designated period of time or the another designated period of time and the amount of allowance allocated to each entity during the designated period of time or the another designated period of time; and
(o) repeating steps (i) through (m).

20. A subscribership comprising a plurality of entities located in a geographic region utilizing a method as in claim 1 for enabling at least one of the entities to comply with an environmental regulation regarding a pollutant to be discharged in the geographic region from at least one point source operated by at least one of the entities during a designated period of time.

21. A method for complying with an environmental regulation regarding a pollutant to be discharged in a geographic region from at least one point source operated by at least one entity during a designated period of time, comprising the steps of:
(a) establishing an administrator and a subscribership in communication with the administrator, the subscribership comprising a plurality of entities, at least one of the entities operating the at least one point source in the geographic region;
(b) establishing an amount of discharge of the pollutant from the at least one point source operated by a first entity within the geographic region during a designated period of time;
(c) comparing the amount of discharge of the pollutant from the at least one point source operated by the first entity within the geographic region during the designated period of time and an amount of allowance allocated to the first entity during the designated period of time to assess compliance of the first entity with the environmental regulation;
(d) establishing a value for the amount of allowance to be allocated by the first entity to discharge the pollutant from the at least one point source operated by the first entity within the geographic region during the designated period of time;
(e) communicating the value established in step (d) to the administrator or to a second entity;
(f) defining a solution enabling the first entity of the subscribership to comply with the environmental regulation, wherein the solution compares the value established in step (d) and a value for an amount of allowance to be allocated by the second entity to discharge the pollutant within the geographic region during the designated period of time; and
(g) implementing the solution defined in step (f).

22. A system for enabling an entity of a group comprising a plurality of entities located in a geographic region to comply with an environmental regulation regarding a pollutant to be discharged in the geographic region from at least one point source operated by at least one entity, comprising:
(a) an administrator in communication with at least two of the entities of the group;
(b) means for establishing an amount of discharge of the pollutant from the at least one point source operated by a first entity within the geographic region during a designated period of time;
(c) means for comparing the amount of discharge of the pollutant from the at least one point source operated by the first entity within the geographic region during the designated period of time and an amount of allowance allocated to the first entity during the designated period of time to assess compliance of the first entity with the environmental regulation;
(d) means for establishing a value for the amount of allowance to be allocated by the first entity to discharge the pollutant from the at least one point source operated by the first entity within the geographic region during the designated period of time;
(e) means for communicating the value established in element (d) to the administrator or to a second entity; and
(f) means for defining a solution enabling the first entity of the group to comply with the environmental regulation, wherein the solution compares the value established in element (d) and a value for an amount of allowance to be allocated by the second entity to discharge the pollutant within the geographic region during the designated period of time.

23. The system of claim 22, wherein at least a portion of the group is a subscribership.

24. The system of claim 23, wherein at least one of the entities of the group is a subscriber of the subscribership.

25. A system as in claim 22, further comprising:
(g) means for implementing the solution defined in element (f).
